(19) United States
(12) Patent Application Publication
(10) Pub. No.: US 2012/0099671 A1
(43) Pub. Date: Apr. 26, 2012

(54) DIGITAL-INTENSIVE SIGNAL PROCESSOR

(76) Inventor: Ping-Ying WANG, Hsinchu City (TW)

(21) Appl. No.: 13/282,215

(22) Filed: Oct. 26, 2011

Related U.S. Application Data
(60) Provisional application No. 61/406,808, filed on Oct. 26, 2010.

(51) Int. Cl. H04L 27/00

(52) U.S. Cl. 375/295

(57) ABSTRACT

A digital-intensive signal processor including a signal converting module and a feedback module in a closed timing loop. The signal converting module converts a control signal to an output signal with phase/frequency related to the control signal. The feedback module detects the phase difference between a reference signal and a feedback signal and generates an original control signal based on the phase difference, so as to keep the phases of the output signal and the reference signal related. The feedback signal is associated with the output signal. The control signal includes the original control signal and a signal to be processed. The phase difference, original control signal, control signal, or output signal is a processed signal corresponding to the signal to be processed.

### CROSS-REFERENCE TO RELATED APPLICATIONS

This application is based upon and claims the benefit of priority to U.S. Provisional Application No. 61/406,808, filed on Oct. 26, 2010; the entire content of which is incorporated herein by reference for all purpose.

### BACKGROUND

The present invention relates to timing loops. In particular, the present invention relates to techniques for implementing a time domain operational amplifier with a closed timing loop.

The function of a closed timing loop is providing output signals with specific phase and/or frequency. For instance, a closed timing loop can generate an output signal and keep the phase of the output signal related with the phase of a reference signal. Phase-locked loops and delay-locked loops widely used in communication systems, multimedia systems, and computer systems are all closed timing loops. Signals generated by closed timing loops are often taken as reference clocks in other circuits.

### SUMMARY

When a closed timing loop is in a stable status, the phase of the reference signal received is substantially the same as the phase of the feedback signal. This characteristic of keeping two phases the same is similar to the function of keeping two input voltages the same in an operational amplifier with a negative feedback structure. Hence, a closed timing loop can be viewed as an operational amplifier in time domain. Many applications of a typical operational amplifier (e.g. analog-to-digital converters, filters, and demodulators) can accordingly be implemented by digital-intensive closed timing loops. Compared with typical circuits providing similar functions, the circuit architectures according to the invention have the advantage of saving chip areas.

One embodiment according to the invention is a digital-intensive signal processor including a signal converting module and a feedback module. The signal converting module and the feedback module form a closed timing loop. The signal converting module converts a control signal to an output signal. The phase or frequency of the output signal is associated with the control signal. The feedback module is used for detecting the phase difference between a reference signal and a feedback signal. Based on the phase difference, the feedback module generates an original control signal, so as to keep the phase of the output signal being related to the phase of the reference signal. The feedback signal is associated with the output signal. The control signal includes a signal to be processed and the original control signal. The phase difference, the original control signal, the control signal, or the output signal is a processed signal corresponding to the signal to be processed.

One embodiment according to the invention is a digital-intensive signal processor including a signal converting module and a feedback module. The signal converting module and the feedback module form a closed timing loop. The signal converting module converts a control signal to an output signal. The phase or frequency of the output signal is associated with the control signal. The feedback module is used for detecting an original phase difference between a reference signal and a feedback signal. The feedback module adds the original phase difference with a signal to be processed, so as to generate a phase difference. Based on the phase difference, the feedback module generates the control signal, so as to keep the phase of the output signal being related to the phase of the reference signal. The feedback signal is associated with the output signal. The phase difference, the original phase difference, the control signal, or the output signal is a processed signal corresponding to the signal to be processed.

One embodiment according to the invention is a digital-intensive signal processor including a signal converting module and a feedback module. The signal converting module and the feedback module form a closed timing loop. The signal converting module converts a control signal to an output signal. The phase or frequency of the output signal is associated with the control signal. The feedback module is used for detecting the phase difference between a signal to be processed and a feedback signal. Based on the phase difference, the feedback module generates the control signal, so as to keep the phase of the output signal being related to the phase of the signal to be processed. The feedback signal is associated with the output signal. The phase difference is a processed signal corresponding to the signal to be processed.

One embodiment according to the invention is a digital-intensive signal processor including a signal converting module and a feedback module. The signal converting module and the feedback module form a closed timing loop. The signal converting module converts a control signal to an output signal. The phase or frequency of the output signal is associated with the control signal. The feedback module is used for detecting the phase difference between a signal to be processed and a feedback signal. Based on the phase difference, the feedback module generates the control signal, so as to keep the phase of the output signal being related to the phase of the signal to be processed. The feedback signal is associated with the output signal. The feedback module generates the control signal with a digital low pass filter, and the control signal is a processed signal corresponding to the signal to be processed.

The advantage and spirit of the invention may be understood by the following recitations together with the appended drawings.

### BRIEF DESCRIPTION OF THE DRAWINGS

FIG. 1 shows the block diagram of the digital-intensive signal processor in one embodiment according to the invention.

FIG. 2(A) shows the block diagram of the digital-intensive signal processor in another embodiment according to the invention.

FIG. 2(B) and FIG. 2(C) illustrate detailed examples of the signal converting module according to the invention.

FIG. 3 illustrates another embodiment further including an acquisition module.

FIG. 4(A) shows an embodiment of connecting two closed timing loops in serial; FIG. 4(B) shows the embodiment further including an acquisition module.

FIG. 5 shows the block diagram of the digital-intensive signal processor in another embodiment according to the invention.

FIG. 6 shows another embodiment further including an acquisition module.

FIG. 7(A) shows another embodiment of connecting two closed timing loops in serial; FIG. 7(B) and FIG. 7(C) are exemplary I/O transfer functions in this embodiment.

FIG. 8, FIG. 9(A), and FIG. 9(B) show the digital-intensive signal processors in three embodiments according to the invention.

### DETAILED DESCRIPTION

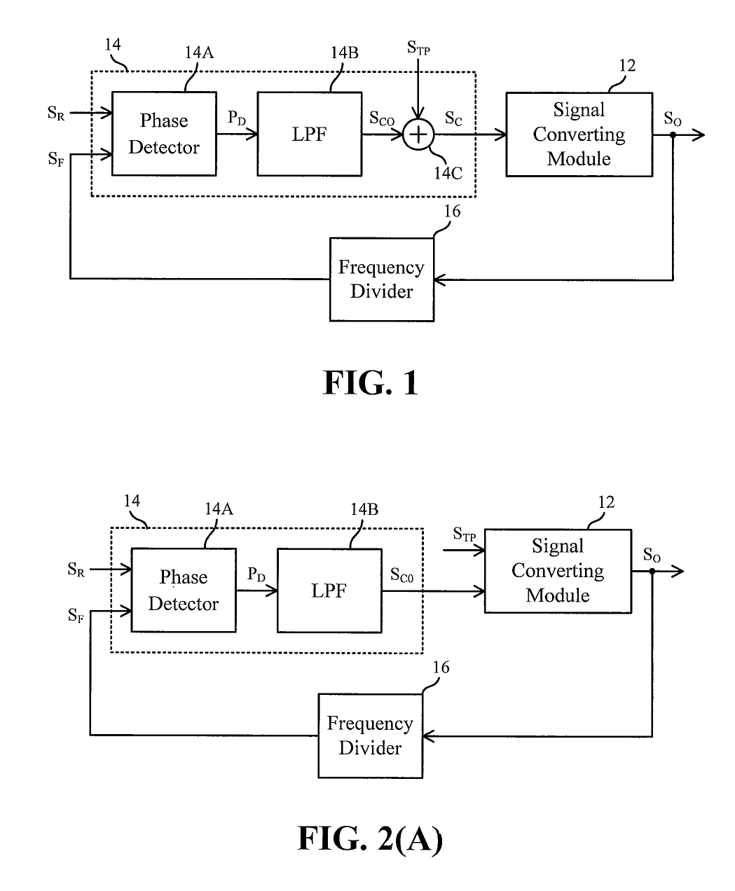

One embodiment according to the invention is the digital-intensive signal processor shown in FIG. 1. The signal processor includes a signal converting module 12, a feedback module 14 and a divider 16. The signal converting module 12 converts a control signal S_{C} to an output signal S_{O} and keeps the phase or frequency of the output signal S_{O} associated with the control signal S_{C}. For example, the signal converting module 12 can be, but not limited to, a voltage-controlled oscillator or a voltage-controlled delay line. In the divider 16, the frequency of the output signal S_{O} is divided by a specific ratio, so as to generate the feedback signal S_{F}. In practice, the divider 16 is not necessary. The feedback signal S_{F} can also be the output signal S_{O} itself.

The feedback module 14 is used for detecting the phase difference between a reference signal S_{R} and the feedback signal S_{F}. Based on the phase difference, the feedback module 14 generates an original control signal S_{C0}, so as to keep the phase of the output signal S_{O} being related to the phase of the reference signal S_{R}. In this embodiment, the feedback module 14 includes a phase detector 14A, a low pass filter (LPF) 14B, and an adder 14C. The phase detector 14A is used for detecting the phase difference P_{C} between the reference signal S_{R} and the feedback signal S_{F}. After filtering the phase difference P_{C} by the low pass filter 14B, the original control signal S_{C0} is generated. The adder 14C adds the original control signal S_{C0} with a signal to be processed S_{TP}, so as to generate the control signal S_{C}. In other words, the control signal S_{C} includes the signal to be processed S_{TP} and the original control signal S_{C0}.

As shown in FIG. 1, the signal converting module 12, divider 16, and feedback module 14 form a closed timing loop. After the closed timing loop reaches a stable status, the phases of the reference signal S_{R} and the feedback signal S_{F} are substantially the same. This characteristic of keeping two phases the same is similar to the function of keeping two input voltages the same in an operational amplifier with a negative feedback structure. Hence, the closed timing loop can be viewed as an operational amplifier in time domain. Many applications of a typical operational amplifier can accordingly be implemented by the signal processor shown in FIG. 1. For the circuit structure in FIG. 1, different signal processing effects can be achieved when acquiring output signals from different nodes. The details are described below.

First, when the signal to be processed S_{TP} is taken as the input and the control signal S_{C} is taken as the output, the transfer function is a high-pass function. Therefore, the control signal S_{C} can be viewed as a processed signal generated by performing a high-pass filtering process on the signal to be processed S_{TP}. In other words, when the signal to be processed S_{TP} is taken as the input and the control signal S_{C} is taken as the output, the closed timing loop is equivalent to a high-pass filter.

Second, when the signal to be processed S_{TP} is taken as the input and the output signal S_{O} is taken as the output, the transfer function is a band-pass function. Therefore, the output signal S_{O} can be viewed as a processed signal generated by performing a band-pass filtering process on the signal to be processed S_{TP}. In other words, when the signal to be processed S_{TF}, is taken as the input and the output signal S_{O} is taken as the output, the closed timing loop is equivalent to a band-pass filter.

Third, when the signal to be processed S_{TP} is taken as the input and the phase difference P_{D} is taken as the output, the transfer function is also a band-pass function. Therefore, the phase difference P_{D} can be viewed as a processed signal generated by performing another band-pass filtering process on the signal to be processed S_{TP}. In other words, when the signal to be processed S_{TP} is taken as the input and the phase difference P_{D} is taken as the output, the closed timing loop is equivalent to another band-pass filter.

Fourth, when the signal to be processed S_{TP} is taken as the input and the original control signal S_{C0} is taken as the output, the transfer function is a low-pass function. Therefore, the original control signal S_{C0} can be viewed as a processed signal generated by performing a low-pass filtering process on the signal to be processed S_{TP}. In other words, when the signal to be processed S_{TP} is taken as the input and the original control signal S_{C0} is taken as the output, the closed timing loop is equivalent to a low-pass filter.

Summing up the above descriptions, the control signal S_{C}, output signal S_{O}, phase difference P_{D}, and original control signal S_{C0} can all be processed signals corresponding to the signal to be processed S_{TP}. A circuit designer can choose one or more output nodes according to practical needs.

It is noted that the signal to be processed S_{TP} can be an analog signal, a digital code, or a pulse-width modulation signal representing voltage level by pulse-width. If the signal to be processed S_{TP} is an analog signal, the phase or frequency of the output signal S_{O} is associated with the voltage of the analog signal. If the signal to be processed S_{TP} is a digital code, the phase or frequency of the output signal S_{O} is associated with the value represented by the digital code. If the signal to be processed S_{TP} is a pulse-width modulation signal, the phase or frequency of the output signal S_{O} is associated with the pulse-width of the pulse-width modulation signal. Similarly, the form of the original control signal S_{C0} is not limited.

For instance, if the signal converting module 12, feedback module 14, and divider 16 form an analog phase-locked loop, the signal to be processed S_{TP} can be an analog signal. When the closed timing loop is an all-digital phase-locked loop, the signal to be processed S_{TP} can be a digital code or a pulse-width modulation signal. When the forms of the signal to be processed S_{TP} and the original control signal S_{C0} are the same, the adder 14C can directly adds the two signals. In practice, when the forms of the two signals are different, the adder 14C can also be responsible for unifying the signal forms.

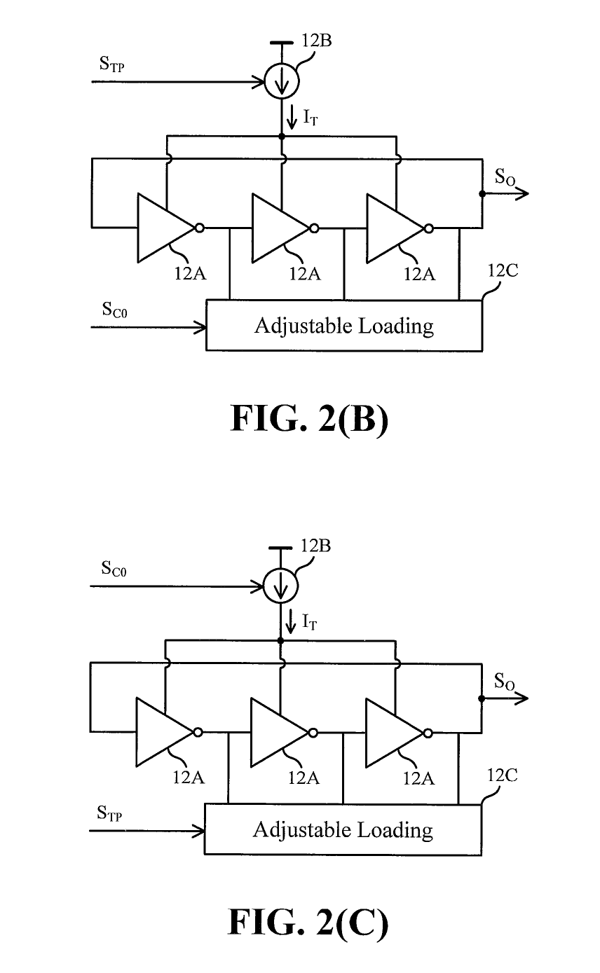

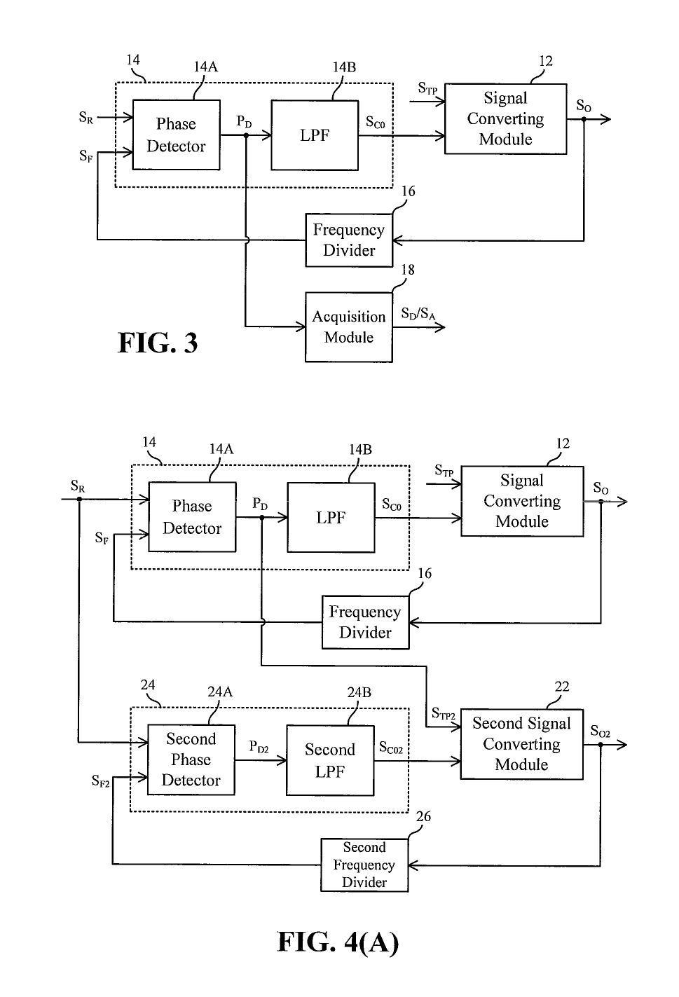

In another embodiment, the original control signal S_{C0} and signal to be processed S_{TP} included in the control signal S_{C} are not added before entering the signal converting module 12. As shown in FIG. 2(A), the original control signal S_{C0} and signal to be processed S_{TP} are provided to the signal converting module 12 respectively and affect the phase or frequency of the output signal S_{O} respectively.

FIG. 2(B) illustrates a detailed example of the signal converting module 12. The signal converting module 12 in this example includes a ring oscillator formed by plural inverters 12A, an adjustable current source 12B for providing operation currents to the inverters 12A, and an adjustable loading 12C. The larger the current I_{T} is, the higher the frequency of the output signal S_{O} is. On the contrary, the larger the loading 12C is, the lower the frequency of the output signal S_{O} is. The signal to be processed S_{TP} is used for controlling the amount of the current I_{T}. The original control signal S_{O0} is used for controlling the amount of the loading 12C. This design is equivalent to adding the original control signal S_{C0} and signal to be processed S_{TP} in time/frequency domain.

FIG. 2(C) illustrates another detailed example of the signal converting module 12. In this example, the signal to be processed S_{TP} is used for controlling the amount of the loading 12C, and the original control signal S_{C0} is used for controlling the amount of the current I_{T}. It is noted, in the circuits shown in FIG. 2(B) and FIG. 2(C), the forms of the original control signal S_{C0} and signal to be processed S_{TP} can be the same or different. Although the circuit structure in FIG. 2(A) is slightly different from that in FIG. 1, the aforementioned filtering effects can be achieved, too.

In one embodiment, the phase detector 14A for detecting the phase difference P_{D} is a digital phase detector. If the signal to be processed S_{TP} is an analog signal and the phase difference P_{D} is taken as the processed signal corresponding to the signal to be processed S_{TP}, the closed timing loop provides both the functions of band-pass filtering and analog-to-digital conversion.

In another embodiment, the low pass filter 14B is a digital low pass filter. If the signal to be processed S_{TP} is an analog signal and the original control signal S_{C0} is taken as the processed signal corresponding to the signal to be processed S_{TP}, the closed timing loop provides both the functions of low-pass filtering and analog-to-digital conversion.

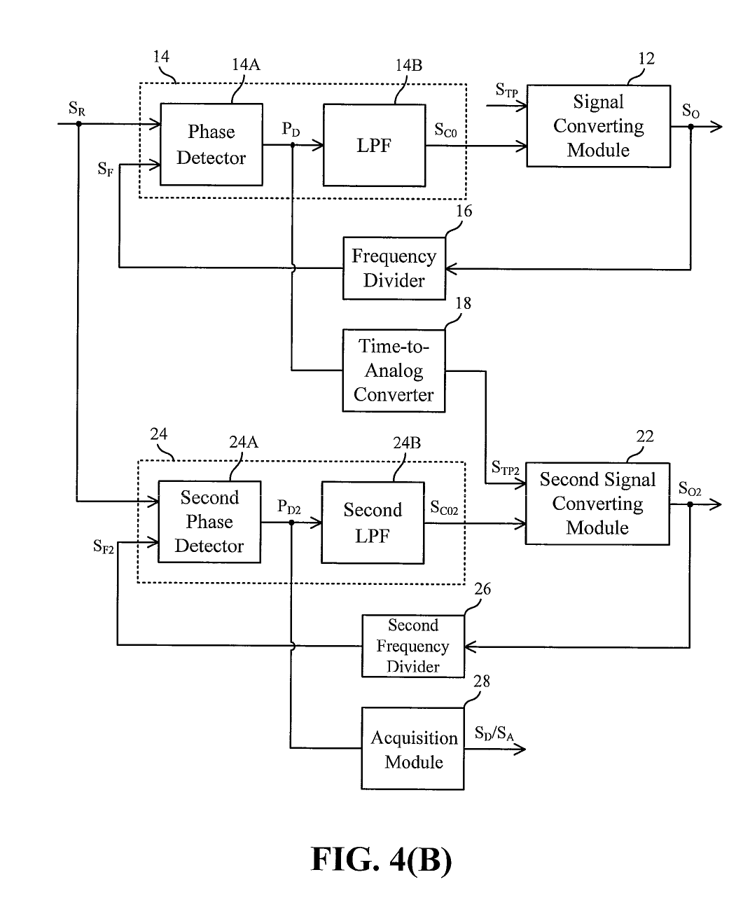

As shown in FIG. 3, in another embodiment according to the invention, the signal processor further includes an acquisition module 18 for converting the phase difference P_{D} (a pulse-width modulation signal) into a digital code S_{D} or an analog signal S_{A}. In practice, the input signal of the acquisition module 18 is not limited to the phase difference P_{D}.

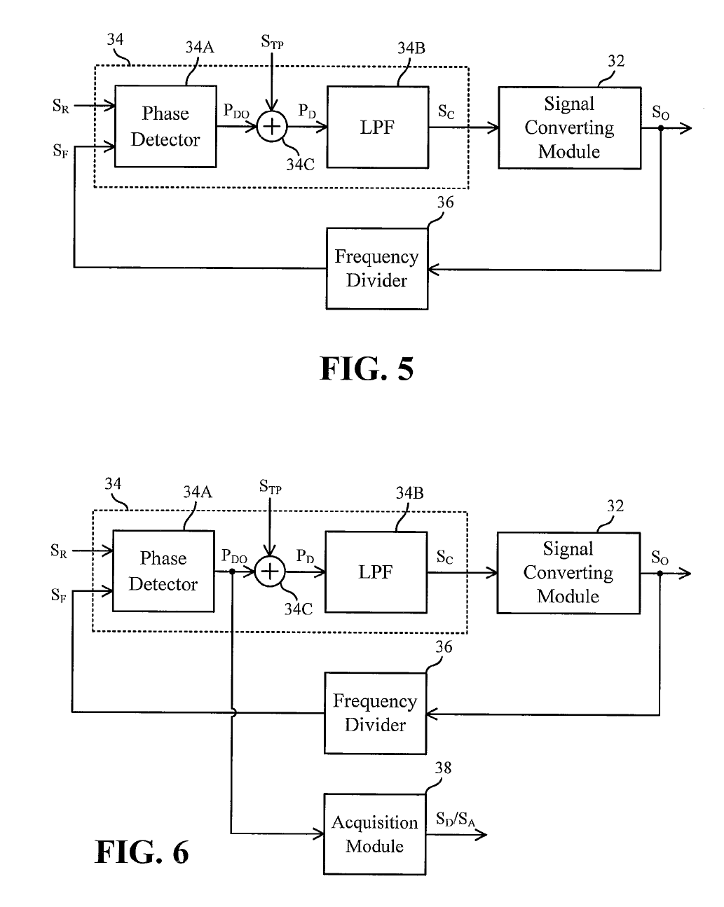

Another embodiment according to the invention is a digital-intensive signal processor formed by connecting two loops shown in FIG. 2 in serial. The function of the signal processor is equivalent to that of two filters connected in serial. The filtering band of the signal processor is associated with both the output nodes of the two closed timing loops. FIG. 4(A) shows an exemplary circuit among the serial combinations. Besides the signal converting module 12, feedback module 14, and divider 16, this signal processor further includes a second signal converting module 22, a second feedback module 24, and a second divider 26. As shown in FIG. 4(A), the three circuit blocks form another closed timing loop. The detailed operation of the circuit blocks has been described above.

In this example, the second signal to be processed S_{TP2} is the phase difference P_{D} outputted by the phase detector 14A. Hence, the first closed timing loop is equivalent to a band-pass filter. If the second phase difference P_{D2} at the output end of the second phase detector 24A is taken as the final output signal, the whole signal processor is equivalent to two band-pass filters connected in serial. In other words, the second phase difference P_{D2} is the result generated by performing two band-pass filtering processes on the signal to be processed S_{TP}. The central frequencies of the two band-pass filters can be the same or different. Appropriately connecting two band-pass filters with slightly different central frequencies in serial can form a band-pass filter with a wider pass-band.

It is noted the connection relation between the two filters is not limited to the one shown in FIG. 4(A). Moreover, the second original control signal Sₐₘ or the second output signal S_{O2} can also be taken as a further-processed signal corresponding to the signal to be processed S_{TP}. If the second closed timing loop in FIG. 4(A) is replaced by the closed timing loop in FIG. 1, the second control signal S_{C2} equivalent to the sum of the second original control signal S_{C02} and the second signal to be processed S_{TP2} can also be taken as the final output signal.

In practice, the second signal to be processed S_{TP2} does not have to be the processed signal P_{D} itself. The second signal to be processed S_{TP2} can also be other signals generated based on the processed signal P_{D}. As shown in FIG. 4(B), an acquisition module (time-to-analog converter) 18 can be connected between the two closed timing loops. The time-to-analog converter 18 is used for converting the phase difference P_{D} into an analog signal for serving as the second signal to be processed S_{TP2}. The signal processor can also further include another acquisition module 28 for converting the further-processed signal (i.e. second phase difference P_{D2}) into a digital code S_{D} or an analog signal S_{A}.

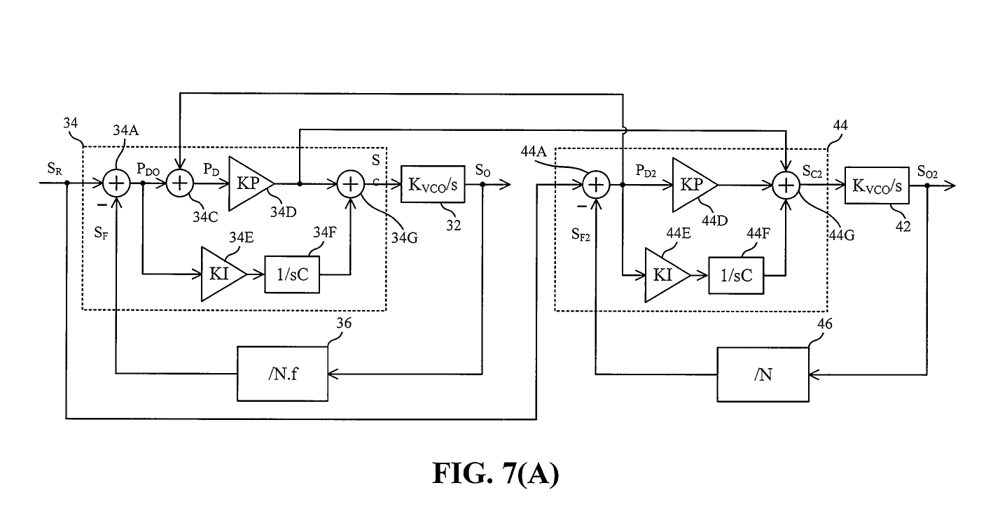

Another embodiment according to the invention is the digital-intensive signal processor shown in FIG. 5. This signal processor includes a signal converting module 32, a feedback module 34, and a divider 36 forming a closed timing loop. The signal converting module 32 converts a control signal S_{C} to an output signal S_{O} and keeps the phase or frequency of the output signal S_{O} associated with the control signal S_{C}. In the divider 36, the frequency of the output signal S_{O} is divided by a specific ratio, so as to generate the feedback signal S_{F}. In practice, the divider 36 is not necessary. The feedback signal S_{F} can also be the output signal S_{O} itself.

The feedback module 34 includes a phase detector 34A, a low pass filter 34B, and an adder 34C. The phase detector 34A is used for detecting the phase difference (hereinafter referred as original phase difference P_{D0}) between a reference signal S_{R} and the feedback signal S_{F}. The adder 34C receives a signal to be processed S_{TP} and adds the signal to be processed S_{TP} with the original phase difference P_{D0}, so as to generate a phase difference P_{D}. The low pass filter 34B is used for filtering the phase difference P_{D}, so as to generate the control signal S_{C}. The control signal S_{C} provided by the feedback module 34 can keep the phase of the output signal S_{O} associated with the phase of the reference signal S_{R}.

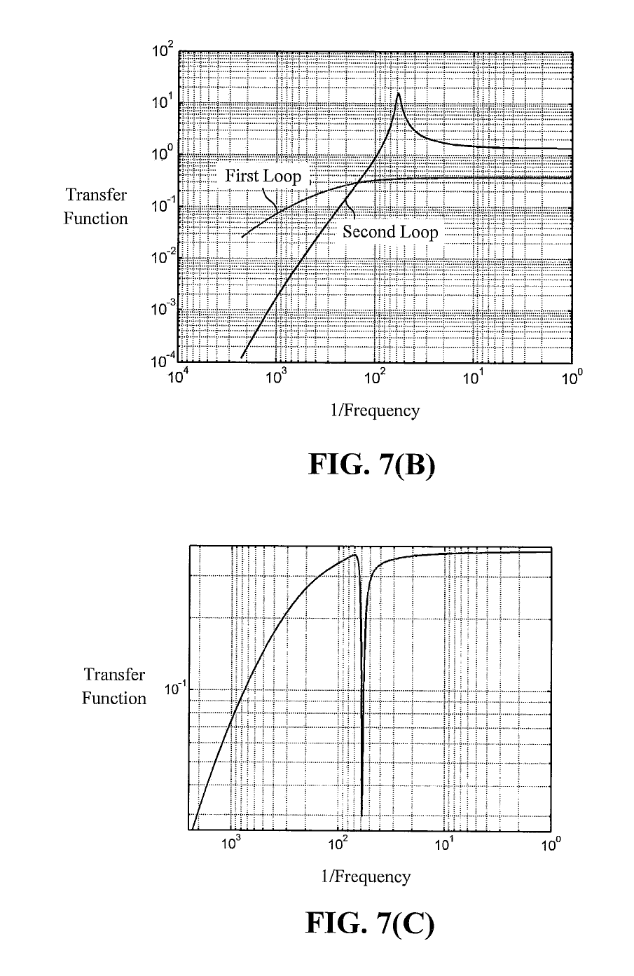

If the signal to be processed S_{TP} shown in FIG. 5 is taken as the input signal, different signal processing effects can be achieved when acquiring output signals from different nodes. In practice, the phase difference P_{D}, original phase difference P_{D0}, control signal S_{C}, and the output signal S_{O} can all be processed signals corresponding to the signal to be processed S_{TP}. A circuit designer can choose one or more output nodes according to practical needs. In the example shown in FIG. 6, the original phase difference P_{D0} is taken as the processed signal and an acquisition module 38 is further included for converting the original phase difference P_{D0} (a pulse-width modulation signal) into a digital code S_{D} or an analog signal S_{A}.

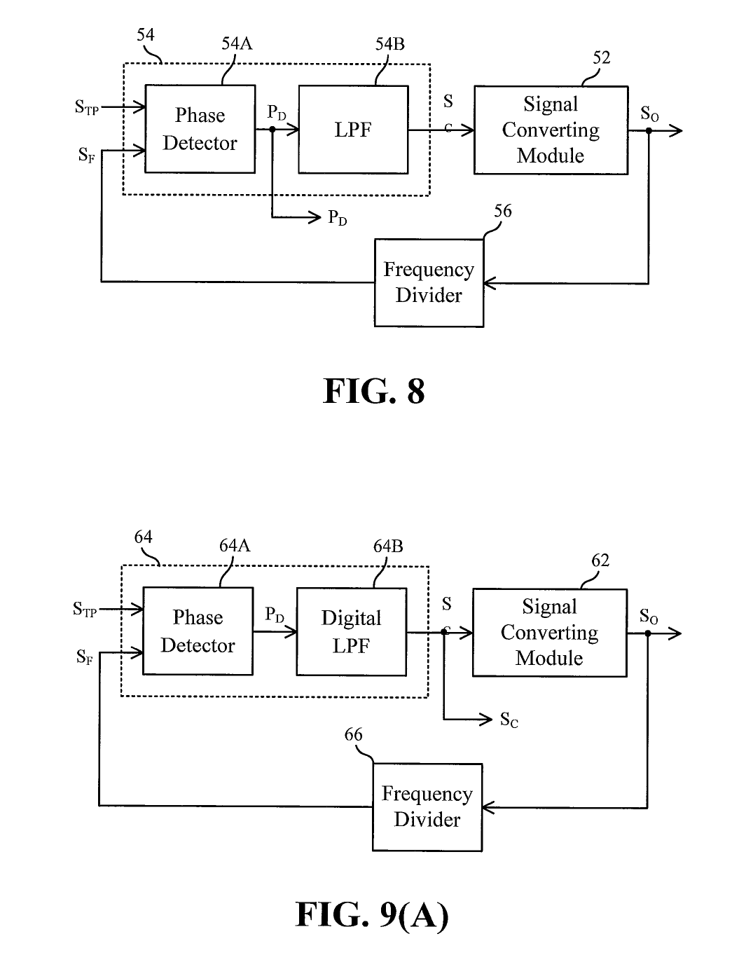

Another embodiment according to the invention is a digital-intensive signal processor formed by connecting the loop shown in FIG. 2 and the loop shown in FIG. 5 in serial. The function of the signal processor is equivalent to that of two filters connected in serial. The filtering band of the signal processor is associated with both the output nodes of the two closed timing loops. FIG. 7(A) shows an exemplary circuit among the serial combinations. Compared with the circuit in FIG. 5, this signal processor further includes a second signal converting module 42, a second feedback module 44, and a second divider 46. As shown in FIG. 7(A), the three circuit blocks form another closed timing loop.

In this embodiment, the divider 36 is a fractional-N divider, and the second divider 46 is an integer divider. Moreover, the feedback modules 34 and 44 respectively include a proportional path and an integral path. Taking the feedback module 34 for explanation, the phase detector 34A is used for detecting the phase difference (hereinafter referred as original phase difference P_{D0}) between the reference signal S_{R} and the feedback signal S_{F}. The amplifier 34D in the proportional path provides an amplification ratio KP. Besides the amplifier 34E providing an amplification ratio KI, the integral path also includes a low pass filter 34F. The original phase difference P_{D0} outputted by the phase detector 34A is provided to both the adder 34C and the amplifier 34E. The adder 34C adds the original phase difference P_{D0} with the second phase difference P_{D2} provided by the second loop. The adder 34G adds the output signals of the amplifier 34D and the low pass filter 34F, so as to generate the control signal S_{C} for controlling the signal converting module 32.

As shown in FIG. 7(A), besides the output signals of the amplifier 44D and low pass filter 44F, the output signal of the amplifier 34D is also an input of the adder 44G in the feedback module 44. In other words, the control signal S_{C2} received by the second signal converting module 42 includes both the original control signal generated by the feedback module 44 and an external signal provided by the first loop.

In this embodiment, the I/O transfer functions of the signal converting modules 32 and 42 are respectively designed as those shown in FIG. 7(B). If the reference signal S_{R} is taken as the input and the output signal S_{O} is taken as the output, the signal processor in FIG. 7 is equivalent to a notch filter; its I/O transfer function is shown in FIG. 7(C).

In practice, the signal provided from the first loop to the adder 44G can be another signal generated based on the processed signal. Moreover, the signal fed back from the second loop to the adder 34C can be another signal different from the second phase difference P_{D2}. Different input/output combinations can achieve different signal processing effects. Furthermore, the second phase difference P_{D2}, second output signal S_{O2}, second control signal S_{C2}, or the second original control signal generated in the second loop can all be taken as further-processed signals corresponding to the reference signal S_{R}.

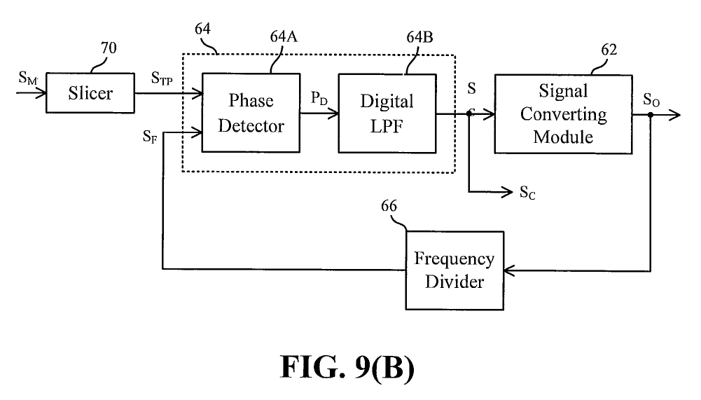

Another embodiment according to the invention is the digital-intensive signal processor shown in FIG. 8. This signal processor includes a signal converting module 52, a feedback module 54, and a divider 56 forming a closed timing loop. The signal converting module 52 converts a control signal S_{C} to an output signal S_{O} and keeps the phase or frequency of the output signal S_{O} associated with the control signal S_{C}. In the divider 56, the frequency of the output signal S_{O} is divided by a specific ratio, so as to generate the feedback signal S_{F}. The feedback module 54 is used for detecting the phase difference P_{D} between a signal to be processed S_{TP} and the feedback signal S_{F}. Based on the phase difference P_{D}, the feedback module 54 generates the control signal S_{C}, so as to keep the phase of the output signal S_{O} associated with the phase of the signal to be processed S_{TP}. As shown in FIG. 8, the feedback module 54 includes a phase detector 54A and a low pass filter 54B. In this embodiment, the phase difference P_{D} provided by the phase detector 54A is the processed signal corresponding to the signal to be processed S_{TP}.

Another embodiment according to the invention is the digital-intensive signal processor shown in FIG. 9(A). This signal processor includes a signal converting module 62, a feedback module 64, and a divider 66 forming a closed timing loop. The feedback module 64 includes a phase detector 64A and a digital low pass filter 64B. The signal converting module 62 converts a control signal S_{C} to an output signal S_{O} and keeps the phase or frequency of the output signal S_{O} associated with the control signal S_{C}. In the divider 66, the frequency of the output signal S_{O} is divided by a specific ratio, so as to generate the feedback signal S_{F}. The feedback module 64 is used for detecting the phase difference P_{D} between a signal to be processed S_{TP} and the feedback signal S_{F}. Based on the phase difference P_{D}, the feedback module 64 generates the control signal S_{C}, so as to keep the phase of the output signal S_{O} being related to the phase of the signal to be processed S_{TP}.

In the embodiment shown in FIG. 9(A), the control signal S_{C} generated by the digital low pass filter 64B is the processed signal corresponding to the signal to be processed S_{TP}. In practice, the transfer function from the signal to be processed S_{TP} to the control signal S_{C} is a low-pass filtering function. Therefore, the control signal S_{C} can be viewed as a processed signal generated by performing a low-pass filtering process on the signal to be processed S_{TP}. Because the low pass filter 64B is a digital low pass filter, besides the low-pass filtering function, this circuit also provides the function of digitizing the filtered signal.

As shown in FIG. 9(B), in another embodiment, the signal processor can further include a slicer 70. The initial input of this processor is an analog frequency-modulation signal S_{M} and is converted to the signal to be processed S_{TP} by the slicer 70. Since this signal processor provides both the functions of frequency down-conversion and analog-to-digital conversion, the control signal S_{C} is the result of performing demodulation and digitalization on the analog frequency-modulation signal S_{M}.

As described above, in the circuit architectures proposed in the invention, the characteristic of taking the closed timing loop as an operational amplifier in time domain is utilized. Analog-to-digital converters, filters, and demodulators can be implemented with digital-intensive signal processor according to the invention. Compared with typical circuits providing similar functions, the circuit architectures according to the invention have the advantage of saving chip areas.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A digital-intensive signal processor, comprising:
a signal converting module for converting a control signal to an output signal, the phase or frequency of the output signal being associated with the control signal, the control signal comprising a signal to be processed and an original control signal; and
a feedback module for detecting the phase difference between a reference signal and a feedback signal, the feedback module generating the original control signal based on the phase difference, so as to keep the phase of the output signal being related to the phase of the reference signal, wherein the feedback signal is associated with the output signal;
wherein the feedback module and the signal converting module form a closed timing loop, and the phase difference, the original control signal, the control signal, or the output signal is a processed signal corresponding to the signal to be processed.

2. The digital-intensive signal processor of claim 1, wherein if the signal to be processed is an analog signal, the phase or frequency of the output signal is associated with the voltage of the analog signal; if the signal to be processed is a digital code, the phase or frequency of the output signal is associated with the digital code; if the signal to be processed is a pulse-width modulation signal, the phase or frequency of the output signal is associated with the pulse-width of the pulse-width modulation signal.

3. The digital-intensive signal processor of claim 1, wherein the feedback module comprises:
a phase detector for detecting the phase difference; and
a low pass filter for filtering the phase difference, so as to generate the original control signal.

4. The digital-intensive signal processor of claim 3, wherein the feedback module further comprises:
an adder for receiving the signal to be processed and adding the signal to be processed with the original control signal, so as to generate the control signal.

5. The digital-intensive signal processor of claim 3, wherein the signal to be processed and the original control signal are provided to the signal converting module respectively and affect the phase or frequency of the output signal respectively.

6. The digital-intensive signal processor of claim 1, wherein the feedback module detects the phase difference with a digital phase detector and the phase difference is the processed signal.

7. The digital-intensive signal processor of claim 1, wherein the feedback module generates the original control signal with a digital low pass filter and the original control signal is the processed signal.

8. The digital-intensive signal processor of claim 1, wherein the processed signal is a pulse-width modulation signal; the digital-intensive signal processor further comprising:
an acquisition module for converting the processed signal into a digital code or an analog signal.

9. The digital-intensive signal processor of claim 1, further comprising:
a second signal converting module for converting a second control signal to a second output signal, the phase or frequency of the second output signal being associated with the second control signal, the second control signal comprising a second signal to be processed and a second original control signal; and
a second feedback module for detecting a second phase difference between a second reference signal and a second feedback signal, the second feedback module generating the second original control signal based on the second phase difference, so as to keep the phase of the second output signal being related to the phase of the second reference signal, wherein the second feedback signal is associated with the second output signal;
wherein the second feedback module and the second signal converting module form another closed timing loop; the second signal to be processed is the processed signal or generated based on the processed signal; the second phase difference, the second original control signal, the second control signal, or the second output signal is a further-processed signal corresponding to the signal to be processed.

10. The digital-intensive signal processor of claim 9, wherein the second phase difference is the further-processed signal; the digital-intensive signal processor further comprising:
a time-to-analog converter for converting the phase difference to an analog signal, so as to generate the second signal to be processed; and
an acquisition module for converting the second phase difference to a digital code or an analog signal.

11. A digital-intensive signal processor, comprising:
a signal converting module for converting a control signal to an output signal, the phase or frequency of the output signal being associated with the control signal; and
a feedback module for detecting an original phase difference between a reference signal and a feedback signal; the feedback module adding the original phase difference with a signal to be processed, so as to generate a phase difference; the feedback module generating the control signal based on the phase difference, so as to keep the phase of the output signal being related to the phase of the reference signal, wherein the feedback signal is associated with the output signal;
wherein the feedback module and the signal converting module form a closed timing loop, and the phase difference, the original phase difference, the control signal, or the output signal is a processed signal corresponding to the signal to be processed.

12. The digital-intensive signal processor of claim 11, wherein the feedback module comprises:
a phase detector for detecting the original phase difference;
an adder for receiving the signal to be processed and adding the signal to be processed with the original phase difference, so as to generate the phase difference; and
a low pass filter for filtering the phase difference, so as to generate the control signal.

13. The digital-intensive signal processor of claim 11, wherein the processed signal is a pulse-width modulation signal; the digital-intensive signal processor further comprising:
an acquisition module for converting the processed signal into a digital code or an analog signal.

14. The digital-intensive signal processor of claim 11, further comprising:
a second signal converting module for converting a second control signal to a second output signal, the phase or frequency of the second output signal being associated with the second control signal, the second control signal comprising a second signal to be processed and a second original control signal; and
a second feedback module for detecting a second phase difference between a second reference signal and a second feedback signal, the second feedback module generating the second original control signal based on the second phase difference, so as to keep the phase of the second output signal being related to the phase of the second reference signal, wherein the second feedback signal is associated with the second output signal;
wherein the second feedback module and the second signal converting module form another closed timing loop; the second signal to be processed is the processed signal or generated based on the processed signal; the second phase difference, the second original control signal, the second control signal, or the second output signal is a further-processed signal corresponding to the signal to be processed.

15. The digital-intensive signal processor of claim 14, wherein the second phase difference is provided to the feedback module and taken as the signal to be processed.

16. A digital-intensive signal processor, comprising:
a signal converting module for converting a control signal to an output signal, the phase or frequency of the output signal being associated with the control signal; and
a feedback module for detecting the phase difference between a signal to be processed and a feedback signal, the feedback module generating the control signal based on the phase difference, so as to keep the phase of the output signal being related to the phase of the signal to be processed, wherein the feedback signal is associated with the output signal;
wherein the feedback module and the signal converting module form a closed timing loop, and the phase difference is a processed signal corresponding to the signal to be processed.

17. A digital-intensive signal processor, comprising:
a signal converting module for converting a control signal to an output signal, the phase or frequency of the output signal being associated with the control signal; and
a feedback module for detecting the phase difference between a signal to be processed and a feedback signal, the feedback module generating the control signal based on the phase difference, so as to keep the phase of the output signal being related to the phase of the signal to be processed, wherein the feedback signal is associated with the output signal;
wherein the feedback module and the signal converting module form a closed timing loop, the feedback module generates the control signal with a digital low pass filter, and the control signal is a processed signal corresponding to the signal to be processed.

18. The digital-intensive signal processor of claim 17, further comprising:
a slicer for converting an analog frequency-modulation signal to the signal to be processed.
